(19) United States
(12) Patent Application Publication
(10) Pub. No.: US 2012/0179314 A1
(43) Pub. Date: Jul. 12, 2012

(54) Vehicle Range Surplus Display And Method

(75) Inventors: Dale Gilman, Beverly Hills, MI (US); Paul Aldighieri, Grosse Pointe Farms, MI (US)

(73) Assignee: FORD GLOBAL TECHNOLOGIES, LLC, Dearborn, MI (US)

(21) Appl. No.: 12/985,719

(22) Filed: Jan. 6, 2011

(51) Int. Cl. G06F 17/00

(52) U.S. Cl. 701/22

(57) ABSTRACT

An information display for a vehicle may convey whether an on-board energy storage device contains surplus energy to propel the vehicle beyond its current destination. The energy surplus may be conveyed in a graphically emotive display to support a driver's emotional motivation to drive the vehicle as well as provide reassurance for successfully making it to a destination before the energy storage device is depleted. The display may include one or more emotive display elements or themes. The energy surplus may be conveyed as surplus distance by a number of surplus indicators that are associated with the emotive display element.

### TECHNICAL FIELD

The present application relates to an apparatus and method for displaying an amount of surplus energy available in an energy storage device relative to a target.

### BACKGROUND

All vehicles, whether passenger or commercial, include a number of gauges, indicators, and various other displays to provide the vehicle operator with information regarding the vehicle and its surroundings. With the advent of new technologies, such as hybrid electric vehicles (HEVs), plug-in hybrid electric vehicle (PHEVs) and battery electric vehicles (BEVs), has come a variety of new gauges and information displays that help guide drivers to better learn, understand and trust the operation of these vehicles that utilize new technology. For example, many HEVs incorporate gauges that attempt to provide the driver with information on the various hybrid driving states. Some gauges will indicate to the driver when the vehicle is being propelled by the engine alone, the motor alone, or a combination of the two. Similarly, a display may indicate when the motor is operating as a generator, and is recharging an energy storage device, such as a battery.

It is known that some drivers may not be able to achieve desired fuel economy or energy efficiency numbers, in part because of driving habits. In many cases, drivers are willing to modify their behavior, but are unable to translate recommended techniques into real changes in their driving habits. In comparison to vehicles that rely on an internal combustion engine for locomotion, electric vehicles, such as BEVs, have limited and comparatively more variable range. Electric vehicles can also take a longer time to recharge or refuel and have relatively fewer locations at which to recharge. These can all contribute to a feeling of range anxiety. With the increase in sensing electronics, computers and other related technology on board a vehicle, the amount of information that can be communicated to the driver is virtually limitless. Often, the driver may not even know of all the features and capabilities their vehicle has to offer. Displaying certain types of information, particularly information relevant to HEVs, PHEVs or BEVs, can help facilitate economical driving choices and/or indicate whether a vehicle is projected to reach its target.

### SUMMARY

According to one or more embodiments of the present application, an information display for a vehicle may include a display screen having an emotive display element and a number of surplus indicators associated with the emotive display element. The surplus indicators may correspond to an energy surplus value indicative of an estimated amount of additional energy in an energy storage device relative to a target. The energy surplus value may be based upon a calculated distance to the target (DTT) value and a current estimated distance to empty (DTE) value. Further, the energy surplus value may be equal to the estimated DTE value minus the calculated DTT value.

The target may be a destination. Alternatively, the target may correspond to an initial distance value input by a driver or an initial estimated DTE value by default when no target information is provided by a driver. The additional energy in the energy storage device relative to the target may correspond to a distance value and each surplus indicator may represent one distance unit of the additional energy in the energy storage device. Moreover, an increase in the number of surplus indicators may correspond to an increase in the energy surplus value. Likewise, an increase in brightness of the number of surplus indicators may correspond to an increase in the energy surplus value. Similarly, an increase in an area of the display screen filled by the number of surplus indicators may correspond to an increase in the energy surplus value.

According to one or more additional embodiments, an information display system for a vehicle may include an information display and a controller in communication with the information display. The information display may have a display screen including an emotive display element and a number of surplus indicators associated with the emotive display element. The controller may be configured to determine an energy surplus value based upon a calculated distance to a target (DTT) value and a current estimated distance to empty (DTE) value. The controller may be further configured to transmit signals causing the information display to display the number of surplus indicators based upon the energy surplus value. The energy surplus value may be equal to the estimated DTE value minus the calculated DTT value. Moreover, the energy surplus value may be measured in units of distance and each surplus indicator may represent one distance unit. An increase in the number of surplus indicators may correspond to an increase in the energy surplus value. The target may correspond to a navigation waypoint. Alternatively, the target may correspond to an initial estimated DTE value by default when no target information is provided by a driver.

According to one or more additional embodiments of the present application, a display method for a vehicle may include calculating a distance from the vehicle to a target (DTT), estimating a range of the vehicle, and determining an energy surplus value based upon the calculated DTT and the estimated vehicle range. The method may further include transmitting signals causing an information display to display a number of surplus indicators based upon the energy surplus value. The step of determining an energy surplus value based upon a calculated distance to a target (DTT) value and a current estimated distance to empty (DTE) value may include subtracting the calculated DTT from the estimated vehicle range. The number of surplus indicators may be directly related to the energy surplus value. Moreover, the target may correspond to a charging location and the estimated vehicle range may correspond to a distance the vehicle can travel before its energy source for locomotion is depleted.

### BRIEF DESCRIPTION OF THE DRAWINGS

FIG. 1 is a simplified, exemplary schematic representation of a vehicle including an information display system according to one or more embodiments of the present application;

FIG. 2a depicts an exemplary information display according to one or more embodiments of the present application;

FIG. 2b depicts an alternate view of the information display in FIG. 2a;

FIG. 3a depicts an exemplary information display according to one or more alternate embodiments of the present application;

FIG. 3b depicts an alternate view of the information display in FIG. 3a;

FIG. 4a depicts another exemplary information display according to one or more alternate embodiments of the present application; and

FIG. 4b depicts an alternate view of the information display in FIG. 4a.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As required, detailed embodiments of the present application are disclosed herein; however, it is to be understood that the disclosed embodiments are merely exemplary of an invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ one or more embodiments of the present application.

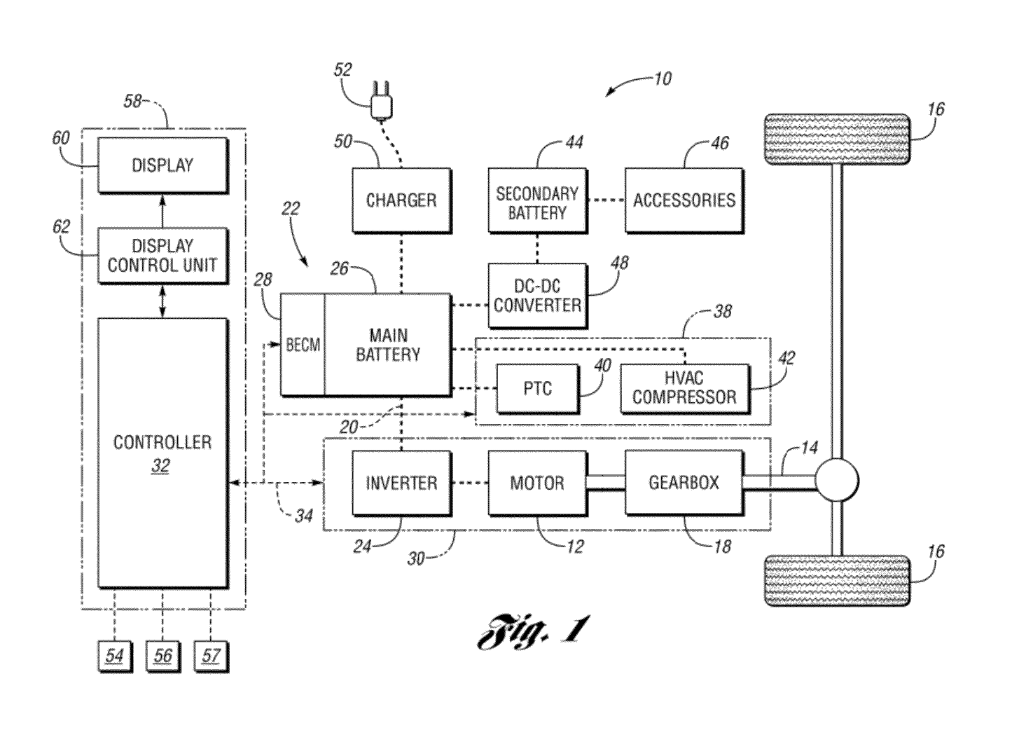

Referring now to the drawings, FIG. 1 is a simplified, exemplary schematic representation of a vehicle 10. As seen therein, the vehicle 10 may be a battery electric vehicle (BEV), which is an all-electric vehicle propelled by one or more electric machines without assistance from an internal combustion engine. The one or more electric machines of the vehicle 10 may include a traction motor 12. The motor 12 may output torque to a shaft 14, which may be connected to a first set of vehicle drive wheels, or primary drive wheels 16, through a gearbox 18. Other vehicles within the scope of the present application may have different electric machine arrangements, such as more than one traction motor. In the embodiment shown in FIG. 1, the traction motor 12 can be used as a motor to output torque to propel the vehicle 10. Alternatively, the motor 12 can also be used as a generator, outputting electrical power to a high voltage bus 20 and to an energy storage system 22 through an inverter 24.

The energy storage system 22 may include a main battery 26 and a battery energy control module (BECM) 28. The main battery 26 may be a high voltage battery that is capable of outputting electrical power to operate the motor 12. According to one or more embodiments, the main battery 26 may be a battery pack made up of several battery modules. Each battery module may contain a plurality of battery cells. The battery cells may be air cooled using existing vehicle cabin air. The battery cells may also be heated or cooled using a fluid coolant system. The BECM 28 may act as a controller for the main battery 26. The BECM 28 may also include an electronic monitoring system that manages temperature and state of charge of each of the battery cells. Other types of energy storage systems can be used with a vehicle, such as the vehicle 10. For example, a device such as a capacitor can be used, which, like a high voltage battery, is capable of both storing and outputting electrical energy. Alternatively, a device such as a fuel cell may be used in conjunction with a battery and/or capacitor to provide electrical power for the vehicle 10.

As shown in FIG. 1, the motor 12, the gearbox 18, and the inverter 24 may generally be referred to as a transmission 30. To control the components of the transmission 30, a vehicle control system, shown generally as a vehicle controller 32, may be provided. Although it is shown as a single controller, it may include multiple controllers that may be used to control multiple vehicle systems. For example, the controller 32 may be a vehicle system controller/powertrain control module (VSC/PCM). In this regard, the PCM portion of the VSC/PCM may be software embedded within the VSC/PCM, or it can be a separate hardware device.

A controller area network (CAN) 34 may allow the controller 32 to communicate with the transmission 30 and the BECM 28. Just as the main battery 26 includes a BECM, other devices controlled by the controller 32 may have their own controllers or sub-controllers. For example, the transmission 30 may include a transmission control module (TCM) (not shown), configured to coordinate control of specific components within the transmission 30, such as the motor 12 and/or the inverter 24. For instance, the TCM may include a motor controller. The motor controller may monitor, among other things, the position, speed, power consumption and temperature of the motor 12. Using this information and a throttle command by the driver, the motor controller and the inverter 24 may convert the direct current (DC) voltage supply by the main battery 26 into signals that can be used to drive the motor 12. Some or all of these various controllers can make up a control system, which, for reference purposes, may be the controller 32. Although illustrated and described in the context of the vehicle 10, which is a BEV, it is understood that embodiments of the present application may be implemented on other types of vehicles, such as those powered by an internal combustion engine, either alone or in addition to one or more electric machines (e.g., HEVs, PHEVs, etc.).

The vehicle 10 may also include a climate control system 38. The climate control system 38 may include both heating and cooling components. For instance, the climate control system 38 may include a high voltage positive temperature coefficient (PTC) electric heater and controller 40. The PTC 40 may be used to heat coolant that circulates to a passenger car heater. Heat from the PTC 40 may also be circulated to the main battery 26. The climate control system 38 may also include a high voltage electric HVAC compressor 42. Both the PTC 40 and the HVAC compressor 42 may draw electrical energy directly from the main battery 26. Moreover, the climate control system 38 may communicate with the controller 32. The on/off status of the climate control system 38 can be communicated to the controller 32, and can be based on, for example, the status of an operator actuated switch, or the automatic control of the climate control system 38 based on related functions such as window defrost.

In addition to the main battery 26, the vehicle 10 may include a separate, secondary battery 44, such as a typical 12-volt battery. The secondary battery 44 may be used to power the vehicle's various other accessories, headlights, and the like (collectively referred to herein as accessories 46). A DC-to-DC converter 48 may be electrically interposed between the main battery 26 and the secondary battery 44. The DC-to-DC converter 48 may allow the main battery 26 to charge the secondary battery 44.

The vehicle 10, which is shown as a BEV, may further include an alternating current (AC) charger 50 for charging the main battery 26 using an off-vehicle AC source. The AC charger 50 may include power electronics used to convert the off-vehicle AC source from an electrical power grid to the DC voltage required by the main battery 26, thereby charging the main battery 26 to its full state of charge. The AC charger 50 may be able to accommodate one or more conventional voltage sources from an off-vehicle electrical grid (e.g., 110 volt, 220 volt, etc.). The AC charger 50 may be connected to the off-vehicle electrical grid using an adaptor, shown schematically in FIG. 1 as a plug 52.

Also shown in FIG. 1 are simplified schematic representations of a braking system 54, an acceleration system 56, and a navigation system 57. The braking system 54 may include such things as a brake pedal, position sensors, pressure sensors, or some combination of the two, as well as a mechanical connection to the vehicle wheels, such as the primary drive wheels 16, to effect friction braking. The braking system 54 may also include a regenerative braking system, wherein braking energy may be captured and stored as electrical energy in the main battery 26. Similarly, the acceleration system 56 may include an accelerator pedal having one or more sensors, which, like the sensors in the braking system 54, may communicate information such as throttle input to the controller 32. The navigation system 57 may include a navigation display, a global positioning system (GPS) unit, a navigation controller and inputs for receiving destination information or other data from a driver. The navigation system may also communicate distance and/or location information associated with the vehicle 10, its target destinations, or other relevant GPS waypoints. The controller 32 may communicate with each individual vehicle system to monitor and control vehicle operation according to programmed algorithms and control logic. In this regard, the controller 32 may help manage the different energy sources available and the mechanical power being delivered to the wheels 16 in order to maximize the vehicle's range. The controller 32 may also communicate with a driver as well.

In addition to the foregoing, the vehicle 10 may include an information display system 58 to facilitate communications with a driver. As explained in detail below, the information display system 58 may provide relevant vehicle content to a driver of the vehicle 10 before, during or after operation. As shown in FIG. 1, the information display system 58 may include the controller 32 and an information display 60. The information display system 58 may also include its own control system, which, for reference purposes, may be a display control unit 62. The display control unit 62 may communicate with the controller 32 and may perform control functions on the information display 60, although the controller 32 may also function as the information display's control system. The controller 32 may be configured to receive input that relates to current operating conditions of the vehicle 10. For instance, the controller 32 may receive input signals from the BECM 28, the transmission 30 (e.g., motor 12 and/or inverter 24), the climate control system 38, the braking system 54, the acceleration system 56, or the like. The controller 32 may provide output to the display control unit 62 such that the information display 60 conveys energy consumption and range information, or other information relating to the operation of the vehicle 10 to a driver.

The information display 60 may be disposed within a dashboard (not shown) of the vehicle 10, such as an instrument panel or center console area. Moreover, the information display 60 may be part of another display system, such as the navigation system 57, or may be part of a dedicated information display system. The information display 60 may be a liquid crystal display (LCD), a plasma display, an organic light emitting display (OLED), or any other suitable display. The information display 60 may include a touch screen for receiving driver input associated with selected areas of the information display 60. The information display system 58 may also include one or more buttons (not shown), including hard keys or soft keys, located adjacent the information display 60 for effectuating driver input. Other operator inputs known to one of ordinary skill in the art may also be employed without departing from the scope of the present application.

As previously stated, BEVs such as vehicle 10 may have a limited, and comparatively more variable, range or distance that can be traveled before energy available for locomotion in the main battery 26 is depleted. Accordingly, the range of a vehicle may also be referred to as its distance to empty (DTE) value. How the vehicle 10 is driven can be an important factor in determining how long the remaining charge in the main battery 26 is expected to last. For instance, aggressive driving behavior may reduce the charge level in the main battery 26 more rapidly than relatively conservative driving behavior. To this end, the controller 32 may estimate the vehicle's DTE value based not only upon the amount of battery energy available in the main battery 26 (e.g., its charge level), but also upon an energy consumption profile and/or environmental factors.

The energy consumption profile may in turn be based upon global or local energy usage statistics taken over a pre-defined period, which may be a lifetime, a trip, or some other rolling period of time or distance. Exemplary environmental factors may include weather, traffic, route information (e.g., terrain, speed limits, traffic control elements, etc.), and the like. One or more of the environmental factors may be communicated to the controller 32 via dedicated on-board or off-board electronic modules such as the navigation system 57, a traffic information system (not shown), or the like. The operation of the vehicle 10 may be continuously monitored and analyzed in order to determine the impact of driving behavior on the vehicle's range. As described, the controller 32 may take into account past driving behavior, current driving behavior, and/or predicted future driving behavior when assessing the vehicle's range and constantly updating the estimated DTE value.

In addition to relatively limited range, BEVs may also have limited opportunities to recharge. Moreover, the process of recharging may take a relatively longer time than refueling a conventional vehicle having an internal combustion engine. In order to determine and inform drivers whether they will be able to make it to their next charge point, the controller 32 may also receive information corresponding to a target. The target may be a destination or a navigation waypoint, such as a charging station or other location providing access to an electrical grid (e.g., home). To this end, information corresponding to the target may be received by the navigation system 57 and communicated to the controller 32 with or without driver input. Alternatively, the target information may correspond to an initial distance value input to the controller 32, either directly or indirectly. For example, rather than enter a target destination into the navigation system 57, a driver may instead input a target distance.

Whether initially entered as a geographic location or an initial target distance value, the target information may be used to calculate a current distance to target (DTT) value based upon the vehicle's current location. The current DTT value may be provided to the controller 32 directly from the navigation system 57 based upon a programmed route from the vehicle 10 to the geographic target, or may be calculated by the controller 32 using corresponding information received from the navigation system 57. Alternatively, the current DTT value may be calculated by the controller 32 based upon the initial target distance value input by a driver and the distance covered by the vehicle (e.g., the odometer distance) since the initial target distance was established. For example, if the initial target distance value was entered at the beginning of a trip, the current DTT value may correspond to the initial target distance value minus the current trip distance.

A comparison of the DTT value to the DTE value can determine whether the vehicle 10 is projected to successfully reach its target on the current charge of the main battery 26. For instance, when the estimated DTE value exceeds the current DTT value (e.g., the vehicle range is greater than the distance to the next charge point), the vehicle 10 may be considered to be operating with an energy surplus. An energy surplus may be indicative that the vehicle 10 is projected to reach its target at the current rate of energy consumption. Conversely, when current DTT value exceeds the estimated DTE, then the vehicle 10 may be considered to be operating with an energy deficit or “debt.” An energy debt may be indicative that the vehicle is not projected to reach its intended target unless driving behavior is modified or the target is changed. The magnitude of the energy surplus (or debt) may be measured by calculating an energy surplus value.

Accordingly, the information display 60 may be used to convey vehicle range information and target distance information in a manner that provides drivers with reassurance that they will be able to make it to their next charge point. If the vehicle 10 is not projected to reach its target, the information display 60 may provide drivers with plenty of warning so they can either modify their driving behavior in order to reach the target or change the target altogether. Referring generally to FIGS. 2a-4b, the information display 60 is shown in greater detail in accordance with one or more embodiments of the present application. As seen therein, the information display 60 may display one or more display screens 64 that may change to convey different information to a driver. To that end, the one or more display screens 64 may be selectable or non-selectable and may transition upon receipt of driver or vehicle input at the controller 32 and/or display control unit 62.

As shown in FIGS. 2a-b, the each display screen 64 of the information display 60 may include an emotive display element 66. The emotive display element 66 may be a display theme, concept or background supporting the emotional motivation of drivers to drive an energy efficient vehicle, such as the vehicle 10. According to one or more embodiments of the present application, the emotive display element 66 may be associated with life or nature, as depicted by the exemplary information display 60 in FIGS. 2a-b. Other non-limiting examples of emotive display elements may be associated with light, health, wealth, fulfillment, independence from oil, or the like, some of which are described in greater detail below. The display screen 64 may also include a number of surplus indicators 68 associated with the emotive display element 66. As shown in FIGS. 2a-b, the surplus indicators 68 may be butterflies flying around within the display screen 64 or perched on one or more background objects 70, such as tree branches. Other living objects (e.g., leaves, flowers, trees, animals, etc.) may also make for suitable surplus indicators. The surplus indicators 68 may correspond to the energy surplus value, which, as explained above, may be indicative of an estimated amount of additional energy available in the main battery 26 to propel the vehicle 10 beyond its target.

According to one or more embodiments of the present application, the energy surplus value is a distance value calculated in units of distance. Accordingly, the energy surplus value may be equal to the estimated DTE value less the calculated DTT value. Moreover, the number of surplus indicators 68 that appear on the display screen 64 may have a direct relationship to the energy surplus value. An increase in the number if surplus indicators 68 may correspond to an increase in the energy surplus value. The relationship may be linear. For example, if the energy surplus value is twenty, the information display system 58 may display four surplus indicators 68 on the display screen 64, as shown in FIG. 2a. By the same token, if the energy surplus value is sixty, the information display system 58 may display twelve surplus indicators 68 on the display screen 64, as shown in FIG. 2b. Thus, in this example, each surplus indicator 68 may signify a surplus of five distance units (e.g., mile, kilometer, etc.) of additional energy available to propel the vehicle 10 beyond its target. The relationship may also have one-to-one correspondence. For example, if the energy surplus value is four, the information display system 58 may display exactly four surplus indicators 68 on the display screen 64. If the energy surplus value is instead twelve, the information display system 58 may display twelve surplus indicators 68 on the display screen 64. Thus, in this example, each surplus indicator 68 may signify a surplus of one distance unit (e.g., mile, kilometer, etc.) of additional energy available to propel the vehicle 10 beyond its target.

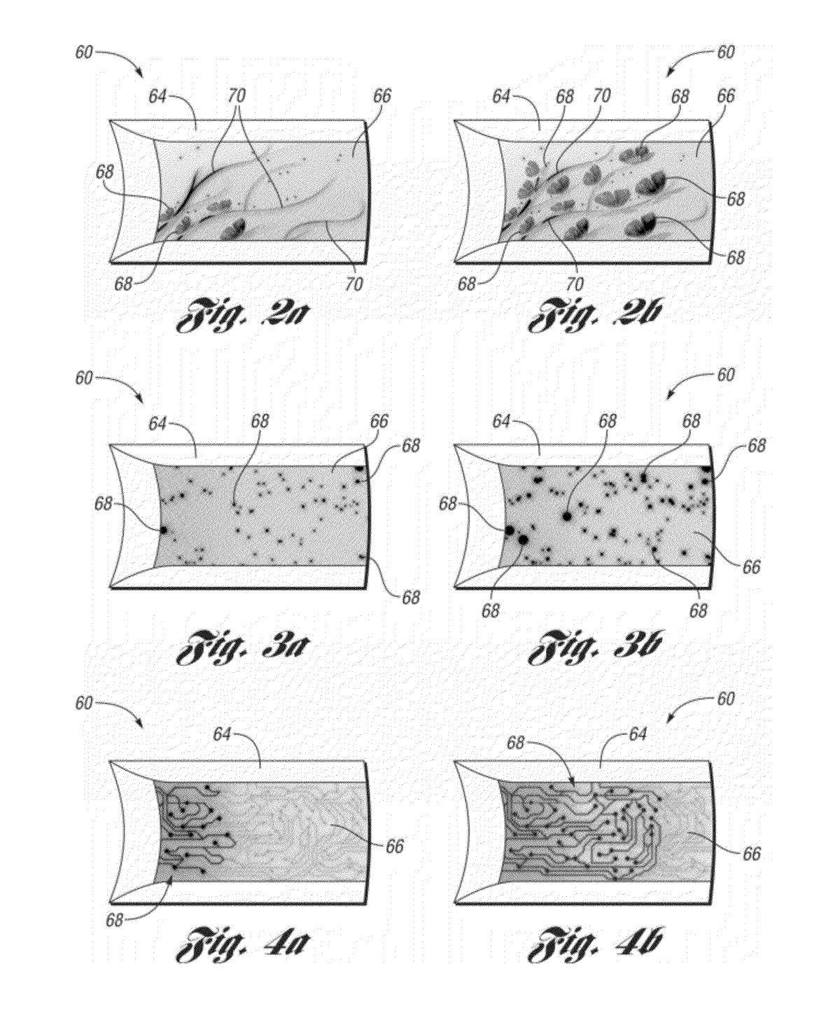

Alternatively, the relationship between the number of surplus indicators 68 to the energy surplus value may be more indirect or abstract. As one example, the energy surplus value may correspond to the brightness of the one or more surplus indicators 68 or the brightness of the display screen 64 in general based upon the number of surplus indicators 68. An increase in the brightness may convey an increase in the energy surplus. For instance, with reference to the exemplary display screens 64 depicted in FIGS. 3a-b, the emotive display element 66 may be associated with light. Moreover, the number of surplus indicators 68 associated with the emotive display element 66 may be stars or particles of light. As shown, the number of surplus indicators 68 displayed in FIG. 3a may be may be virtually equal to the number of surplus indicators displayed in FIG. 3b. However, the brightness of the surplus indicators 68 or the display screen 64 in general is greater in FIG. 3b than in FIG. 3a. Thus, FIG. 3b may convey a relatively greater energy surplus value than FIG. 3a.

Additionally or alternatively, the energy surplus value may correspond to an area or amount of fill of the display screen 64 by the surplus indicators 68. More fill may correspond to more energy surplus. For example, with reference to the exemplary display screens 64 depicted in FIGS. 4a-b, the emotive display element 66 may be associated with fulfillment or electric health, and incorporate a background image, such as a circuit board. Moreover, the number of surplus indicators 68 associated with the emotive display element 66 may be traces in the circuit board. As shown, the amount of fill of the display screen 64 by the surplus indicators 68 in FIG. 4b is greater than that of FIG. 4a. Accordingly, FIG. 4b may convey a relatively greater energy surplus value than FIG. 4a.

According to one or more additional embodiments, the energy surplus value may be a ratio involving the DTT value and the DTE value. As an example, the energy surplus value may be calculated by dividing the DTT value by the DTE value. In this regard, any energy surplus value over 1.0 may correspond to an energy deficit. Moreover, if less than one, a smaller energy surplus value may correspond to a greater energy surplus. As another example, the energy surplus value may be calculated by dividing the difference between the DTE value and the DTT value (i.e., DTE minus DTT) by the DTE value. In this manner, a positive energy surplus value may be indicative of an energy surplus. Moreover, the greater the energy surplus value, the greater the magnitude of the energy surplus.

The information display 60 may be updated in real-time to reflect any ongoing changes to the vehicle or system state. For example, if a driver takes a detour to the target from an expected or programmed route, the vehicle 10 may consult the navigation system 57 to determine a new DTT value. The controller 32 may constantly determine, calculate and/or estimate DTT values, DTE values, or the like. Additionally, the controller 32 may determine whether vehicle 10 has either an energy surplus or an energy deficit based on a comparison of the estimated DTE value and the current DTT value. Moreover, the controller 32 may constantly calculate the energy surplus value based on the current DTE value and DTT value to determine the magnitude of an energy surplus or deficit. Further, the controller 32 may transmit or output signals causing the information display 60 to adjust number of surplus indicators 68 based at least upon the energy surplus value.

In addition to supporting a driver's emotional motivation for driving the vehicle 10, the information display system 58 may also relieve any range anxiety a driver may have by conveying energy surplus information in a graphical, more qualitative manner. By representing an energy surplus, as long as one surplus indicator 68 is present on the display screen 64, drivers may be assured of making it to their target (e.g., destination). Moreover, the more surplus indicators 68 (by quantity, brightness, fill, detail, etc.) on the display screen 64, the more surplus mileage the vehicle 10 has beyond its charge point destination or other designated target.

When no target information is provided, the vehicle 10 may predict a DTT value based on past driving history, such as average trip distance or some other available metric. Alternatively, if a target distance or destination is not entered by a driver or is otherwise unavailable, an initial estimated DTE value at that time may be used as a default or substitute for the target. Moreover, the current DTT value may be obtained by counting down from the initial DTE estimate based on the actual distance traveled (e.g., odometer mileage) since the initial DTE estimate was established. When using an initial DTE estimate as a default target when target information is not entered or becomes unavailable, the information display 60 may help coach drivers to at least obtain the initially estimated DTE. Since the estimated vehicle range or DTE value may be based on an energy consumption profile for a driver, the information display may provide an indication of the driver's current driving behavior against himself or herself. In this regard, the presence or absence of surplus indicators 68 may convey the driver's status in relation to his or her past energy usage history.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An information display for a vehicle comprising:
a display screen including:
an emotive display element, and
a number of surplus indicators associated with the emotive display element, the surplus indicators corresponding to an energy surplus value indicative of an estimated amount of additional energy in an energy storage device relative to a target.

2. The information display of claim 1, wherein the energy surplus value is based upon a calculated distance to the target (DTT) value and a current estimated distance to empty (DTE) value.

3. The information display of claim 2, wherein the energy surplus value is equal to the estimated DTE value minus the calculated DTT value.

4. The information display of claim 2, wherein the target is a destination.

5. The information display of claim 2, wherein the target corresponds to an initial distance value input by a driver.

6. The information display of claim 2, wherein the target corresponds to an initial estimated DTE value by default when no target information is provided by a driver.

7. The information display of claim 1, wherein the additional energy in the energy storage device relative to the target corresponds to a distance value, and each surplus indicator represents one distance unit of the additional energy in the energy storage device.

8. The information display of claim 1, wherein an increase in the number of surplus indicators corresponds to an increase in the energy surplus value.

9. The information display of claim 1, wherein an increase in brightness of the number of surplus indicators corresponds to an increase in the energy surplus value.

10. The information display of claim 1, wherein an increase in an area of the display screen filled by the number of surplus indicators corresponds to an increase in the energy surplus value.

11. An information display system comprising:
an information display having a display screen including:
an emotive display element, and
a number of surplus indicators associated with the emotive display element; and
a controller in communication with the information display and configured to:
determine an energy surplus value based upon a calculated distance to a target (DTT) value and a current estimated distance to empty (DTE) value, and
transmit signals causing the information display to display the number of surplus indicators based upon the energy surplus value.

12. The information display system of claim 11, wherein the energy surplus value is equal to the estimated DTE value minus the calculated DTT value.

13. The information display system of claim 11, wherein the target corresponds to a navigation waypoint.

14. The information display system of claim 11, wherein the target corresponds to an initial estimated DTE value by default when no target information is provided by a driver.

15. The information display system of claim 11, wherein the energy surplus value is measured in units of distance and each surplus indicator represents one distance unit.

16. The information display system of claim 11, wherein an increase in the number of surplus indicators corresponds to an increase in the energy surplus value.

17. A display method comprising:
calculating a distance from a vehicle to a target (DTT);
estimating a range of the vehicle;
determining an energy surplus value based upon the calculated DTT and the estimated vehicle range; and
transmitting signals causing an information display to display a number of surplus indicators based upon the energy surplus value.

18. The display method of claim 17, wherein the step of determining an energy surplus value based upon a calculated distance to a target (DTT) value and a current estimated distance to empty (DTE) value comprises:
subtracting the calculated DTT from the estimated vehicle range.

19. The display method of claim 17, wherein the number of surplus indicators is directly related to the energy surplus value.

20. The display method of claim 17, wherein the target corresponds to a charging location and the estimated vehicle range corresponds to a distance the vehicle can travel before its energy source for locomotion is depleted.
